(19) United States
(12) Patent Application Publication
(10) Pub. No.: US 2025/0256991 A1
(43) Pub. Date: Aug. 14, 2025

(54) FUNCTIONALIZED TRANSITION METAL DICHALCOGENIDES AND USES THEREOF FOR WATER DESALINATION

(71) Applicant: CITY UNIVERSITY OF HONG KONG, Kowloon (HK)

(72) Inventors: Zhiyuan ZENG, Kowloon (HK); Ting YING, Kowloon (HK)

(21) Appl. No.: 18/963,135

(22) Filed: Nov. 27, 2024

Related U.S. Application Data
(60) Provisional application No. 63/553,556, filed on Feb. 14, 2024.

(51) Int. Cl. C02F 1/44; C02F 101/10; C02F 103/08

(52) U.S. Cl. CPC C02F 1/445; C02F 1/442; C02F 2101/10; C02F 2103/08

(57) ABSTRACT

Disclosed herein is a membrane made of stacked layers of thio-groups functionalized single-layer transition metal dichalcogenide (TMD) nanosheets. The membrane is characterized by having a network of water permeation capillary passages independently having a capillary width of about 4.5-5.5 Å, a surface wettability with a contact angle of 64-90°, a degree of functionalization of 10-15%, a degree of swelling of about 0.5-4.0%; and a thickness of about 200-1,300 nm. Also disclosed herein is a method of deionizing a fluid. The method includes permeating the fluid through the present membrane via forward osmosis.

### CROSS-REFERENCE TO RELATED APPLICATIONS

This application claims priority and the benefit of U.S. Provisional Patent Application No. 63/553,556, filed Feb. 14, 2024, the entirety of which is incorporated herein by reference.

### BACKGROUND OF THE INVENTION

### 1. Field of the Invention

The present invention relates to methods of producing electrodes comprising 1T′-phase transition metal dichalcogenide (TMD) nanosheets, and electrochemical capacitator comprising the electrodes for continuous water desalination.

### 2. Description of Related Art

Reclaiming freshwater from seawater or wastewater is a promising approach to alleviate water scarcity in water-stressed areas. To date, semi-permeable membranes have outcompeted other methods in desalination due to their energy-saving, carbon footprint reduction, and sustainability. State-of-the-art nanomaterials are promising for membrane fabrication for selective sieving. Two-dimensional (2D) materials-based membranes, including graphene oxide (GO), MXenes, and transition-metal dichalcogenides (TMDs), have shown great promise in molecular or ion sieving, such as Na⁺, K⁺, and micropollutants, owing to their narrow distribution of nanochannels. Specifically, GO laminates offer well-defined nanometer pores that enable water permeation while blocking hydrated mineral ions with molecular weight cut-off. However, GO laminates are prone to swelling in aqueous solutions, leading to the enlargement of interlayer spacing and uncontrollable microstructure disintegration. Similarly, MXenes membranes also have significant swelling properties due to hydrophilic functional groups attached to their basal plane. Although microstructure instability can be a useful tool under certain scenarios, it is generally detrimental to membrane-based applications due to the lowered performance caused by irreversible degradation. Several alternative approaches have been proposed to address the instability of microstructure in GO or MXenes membranes, such as physical confinement, cationic control and charge compensation. However, these approaches are often complicated which puts additional cost on practical applications.

TMD materials, especially molybdenum disulfide (MoS₂) laminates, are more stable than their analogues GO or MXenes, making them a promising candidate for membrane fabrication. Over the last decade, researchers have investigated the use of MoS₂ nanosheets as matrices for gas or solute separation applications. However, pristine MoS₂ laminates with close-to-ideal stacking are not suitable for mass transport due to their dense and compact channels between consecutive layers. The capillary width of MoS₂ membranes, defined as δ, is crucial for sieving performance and permeation. By adjusting the physical dimensions and surface chemistry of MoS₂ nanosheets, the nanochannel of the nanolaminate membrane can be optimized, offering a promising route for practical MoS₂-based membranes. For example, Hirunpinyopas et al. proposed an interesting functionalization strategy on MoS₂ membranes by using different dyes (crystal violet, sunset yellow, neutral red), which showed very good salt rejection and water fluxes. Forward osmosis (FO) is a membrane process that relies on inherent osmotic pressure to induce water flow from the low concentration side (feed solution) across the semi-permeable membrane to the high concentration side (draw solution). Hence, FO has many potential advantages, including lower energy input, reduced fouling, and higher water recovery compared to pressure-driven processes such as reverse osmosis (RO), nanofiltration (NF), and ultrafiltration (UF).

In view of the above, there exists in the related art a need for an improved MoS₂-based membrane useful for continuous water desalinization.

### SUMMARY

Embodiments of the present disclosure relate to a membrane made of stacked layers of thio-groups functionalized single-layer transition metal dichalcogenide (TMD) nanosheets. The membrane may be used to remove ions in a fluid via forward osmosis (FO).

The first objective of the present disclosure therefore aims to provide a membrane comprising stacked layers of thio-groups functionalized single-layer transition metal dichalcogenide (TMD) nanosheets, wherein, the thio-groups functionalized single-layer TMD nanosheets are produced by reacting a dispersion of single-layer TMD nanosheets with a thiol-group containing compound, wherein the thiol-group containing compound is cysteine, 1-propanethiol, or 3-mercaptopropane-1,2-diol; and the membrane is characterized by having a network of water permeation capillary passages independently having a capillary width of about 4.5-5.5 Å, a surface wettability with a contact angle of 64-90°, a degree of functionalization of 10-15%, a degree of swelling of about 0.5-4.0%; and a thickness of about 200-1,300 nm.

According to embodiments of the present disclosure, the dispersion of single-layer TMD nanosheets are produced by,
(i) discharging a bulk TMD in a lithium battery to produce a lithiated bulk TMD;
(ii) subjecting the lithiated bulk TMD to sonification in water to exfoliate the lithiated bulk TMD into the single-layer-TMD nanosheets;
(iii) collecting the product of step (ii) by centrifugation; and
(iv) re-dispersing the product of step (iii) in water to produce the dispersion of single-layer TMD nanosheets.

According to embodiments of the present disclosure, the single-layer TMD nanosheets are single-layer MoS₂ nanosheets.

According to some embodiments of the present disclosure, the thiol-group containing compound is 1-propanethiol; and the membrane has the network of water permeation capillary passages independently having the capillary width of about 5.2 Å, the surface wettability with the contact angle of about 90°, the degree of functionalization of 10%, and the degree of swelling of about 0.6%.

According to further embodiments of the present disclosure, the thiol-group containing compound is cysteine; and the membrane has the network of water permeation capillary passages independently having the capillary width of about 5.1 Å, the surface wettability with the contact angle of about 65°, the degree of functionalization of 14%, and the degree of swelling of about 1.3%.

According to other embodiments of the present disclosure, the thiol-group containing compound is 3-mercaptopropane-1,2-diol; and the membrane has the network of water permeation capillary passages independently having the capillary width of about 4.7 Å, the surface wettability with the contact angle of about 70°, the degree of functionalization of 10%, and the degree of swelling of about 3.7%.

Accordingly, the second objective of the present disclosure aims at providing a method of deionizing a fluid comprising filtering the fluid through the present membrane via forward osmosis for 24 hrs.

According to some embodiments of the present disclosure, the membrane comprises stacked layers of thio-groups functionalized single-layer TMD nanosheets conferred by 1-propanethiol; and the membrane has the network of water permeation capillary passages independently having the capillary width of about 5.2 Å, the surface wettability with the contact angle of about 90°, the degree of functionalization of 10%, and the degree of swelling of about 0.6%.

According to some embodiments of the present disclosure, the membrane comprises stacked layers of thio-groups functionalized single-layer TMD nanosheets conferred by cysteine; and the membrane has the network of water permeation capillary passages independently having the capillary width of about 5.1 Å, the surface wettability with the contact angle of about 65°, the degree of functionalization of 14%, and the degree of swelling of about 1.3%.

According to other embodiments of the present disclosure, the membrane comprises stacked layers of thio-groups functionalized single-layer TMD nanosheets conferred by 3-mercaptopropane-1,2-diol, and has the network of water permeation capillary passages independently having the capillary width of about 4.7 Å, the surface wettability with the contact angle of about 70°, the degree of functionalization of 10%, and the degree of swelling of about 3.7%.

According to embodiments of the present disclosure, the fluid comprises ions selected from the group consisting of sodium ions, potassium ions, magnesium ions, calcium ions and a combination thereof.

According to preferred embodiments of the present disclosure, the membrane rejects at least 99% of the ions present in the fluid.

Other and further embodiments of the present disclosure are described in more detail below.

### BRIEF DESCRIPTION OF THE DRAWINGS

The disclosure will become more fully understood from the detailed description and the drawings given below for illustration only, and thus does not limit the disclosure, wherein:

FIG. 1 is a bar graph depicting the results of contact angle measurements for non-functionalized MoS₂ membrane and three functionalized MoS₂ membranes in accordance with one embodiment of the present disclosure;

FIG. 2 is a bar graph depicting the swelling properties of different 2D-material-based (GO or MXene) membranes and the functionalized MoS₂ membrane in accordance with one embodiment of the present disclosure;

FIG. 3 is a line graph depicting the water flux (dash lines) and Na⁺ rejection (dash-dotted lines) for MoS₂ and functionalized MoS₂ membranes with varied thickness in accordance with one embodiment of the present disclosure;

FIG. 4 depicts the changes in the water flux of the functionalized MoS₂ membranes after repeated cycles in accordance with one embodiment of the present disclosure;

FIG. 5 is a bar graph depicting rejection of 5 types of slats by the functionalized MoS₂ membrane of 600 nm in accordance with one embodiment of the present disclosure;

FIG. 6 depicts the comparison of NaCl rejection and water flux performance via forward osmosis (FO) measurement in the present functionalized MoS₂ membrane (star) and other 2D material membranes in accordance with one embodiment of the present disclosure;

FIG. 7 is a line graph depicting long-term Na⁺ permeation in FO measurement for the functionalized membranes in accordance with one embodiment of the present disclosure;

FIG. 8 depicts the permeation flux of K⁺, Na⁺, Ca²⁺, Mg²⁺ by using a synthetic seawater as the feed solution in accordance with one embodiment of the present disclosure;

FIG. 9 depicts the ion rejection of the functionalized MoS₂ membranes (600 nm) after 100 hr testing with synthetic seawater in accordance with one embodiment of the present disclosure; and

FIG. 10A-10F Capillary width and ionic rejection. (10A) Fluctuation of capillary width of dry functionalized membranes and soaked in DI water or different saline solution (NaCl, KCl, Na₂SO₄, MgCl₂ and CaCl₂) for 24 h. Rejection performance of Na⁺ (10B), K⁺ (10C), Ca²⁺ (10D), and Mg²⁺ (10E) with respect to capillary width in corresponding solutions. (10F) Variation of Full width at half maximum (FWHM) of three functionalized membranes presented in different solutions. All error bars correspond to the s.d. of at least three samples.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

### 1. The Present Membrane

The first objective of the present disclosure is directed to a membrane made of stacked layers of thio-groups functionalized single-layer TMD nanosheets. The sulfur vacancy sites of TMD nanosheets are grafted with thio-groups thereby creating a structure that may serve as channels for water permeation. Accordingly, the present membrane may serve as an ionic sieve to remove ions from fluid (e.g., sea water).

In order to produce the desired membrane, single-layer TMD nanosheets are modified by grafting a plurality of thio-groups onto the sulfur vacancy sites of the TMD nanosheets to create channels between consecutive nanosheets. According to embodiments of the present disclosure, a dispersion of single-layer TMD nanosheets is reacted with a thio-group containing compound in water or in an organic solution for at least 24 hrs. The choice of the solvent varies with the type of thio-group containing compound employed in the functionalization reaction. Examples of the thio-group containing compound suitable for use in the present disclosure include, but are not limited to, cysteine, 1-propanethiol, and 3-mercaptopropane-1,2-diol. According to embodiments of the present disclosure, the dispersion of single-layer TMD nanosheets are produced by,
(i) discharging a bulk TMD in a lithium battery to produce a lithiated bulk TMD;
(ii) subjecting the lithiated bulk TMD to sonification in water to exfoliate the lithiated bulk TMD into the single-layer-TMD nanosheets;
(iii) collecting the product of step (ii) by centrifugation; and
(iv) re-dispersing the product of step (iii) in water to produce the dispersion of single-layer TMD nanosheets.

Examples of the TMD suitable for producing the present membrane include, but are not limited to, MoS₂, TaS₂, WS₂, TiS₂, MoSe₂, WSe₂, MoTe₂, WTe₂, NbS₂, ReS₂, NbSe₂, ReSe₂, NbTe₂, ReTe₂, NiS₂, NiSe₂, PdS₂, ZrSe₂, PdSe₂, ZrTe₂, PdTe₂, TaSe₂, TaTa₂, TiSe₂, and the like. According to preferred embodiments of the present disclosure, single layer MoS₂ nanosheets are functionalized to produce the present membrane.

According to preferred embodiments of the present disclosure, the membrane thus produced is characterized by having the following characteristics:
i. a network of water permeation capillary passages independently having a capillary width of about 4.5-5.5 Å, such as 4.5, 4.6, 4.7, 4.8, 4.9, 5.0, 5.1, 5.2, 5.3, 5.4 and 5.5 Å;
ii. a surface wettability with a contact angle of 64-90°, such as 64, 65, 66, 67, 68, 69, 7, 71, 72, 73, 74, 75, 76, 77, 78, 79, 80, 81, 82, 83, 84, 85, 86, 87, 88, 89, and 90°;
iii. a degree of functionalization of 10-15%, such as 10, 11, 12, 13, 14, and 15%;
iv. a degree of swelling of about 0.5-4.0%, such as 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, and 4.0%; and
v. a thickness of about 200-1,300 nm, such as 200, 300, 400, 500, 600, 700, 800, 900, 1,000, 1,100, 1,200, and 1,300 nm.

In certain embodiments, the dispersion of single-layer MoS₂ nanosheets is reacted with 1-propanethiol in an organic solution, which is a mixture of water and dimethyl sulfoxide (DMSO) at a volume ratio of 2:1, for at least 24 hrs. The membrane thus produced has the network of water permeation capillary passages independently having the capillary width of about 5.2 Å, the surface wettability with the contact angle of about 90°, the degree of functionalization of 10%, and the degree of swelling of about 0.6%.

In some embodiments, the dispersion of single-layer MoS₂ nanosheets is reacted with cysteine in water for at least 24 hrs, and the membrane thus produced has the network of water permeation capillary passages independently having the capillary width of about 5.1 Å, the surface wettability with the contact angle of about 65°, the degree of functionalization of 14%, and the degree of swelling of about 1.3%.

In further embodiments, the dispersion of single-layer MoS₂ nanosheets is reacted with 3-mercaptopropane-1,2-diol in water for at least 24 hrs, and the membrane thus produced has the network of water permeation capillary passages independently having the capillary width of about 4.7 Å, the surface wettability with the contact angle of about 70°, the degree of functionalization of 10%, and the degree of swelling of about 3.7%.

### 2. Use of the Present Membrane for Removing Charged or Uncharged Solutes From a Fluid

The afore-mentioned membrane is characterized in having a network of water permeation capillary passages independently having a capillary width of about 4.5-5.5 Å, suitable for water permeation, thus, the membrane may be used to remove charged or uncharged solutes in a fluid, such as by gravity-fed filtration, forward osmosis (FO) and the like. According to embodiments of the present disclosure, a fluid (e.g., sea water, a brackish water, and etc.) is permeated through the present membrane for at least 24 hrs, thereby achieving a rejection of charged solutes greater than 96%.

According to some embodiments of the present disclosure, the membrane having thio-groups grafted thereon conferred by reacting MoS₂ nanosheets with 1-propanethiol (i.e., MoS₂-prop membrane) exhibits a water permeation rate of 54.1 mol/m²/h in FO. According to other embodiments of the present disclosure, the membrane having thio-groups grafted thereon conferred by reacting MoS₂ nanosheets with 3-mercaptopropane-1,2-diol (i.e., MoS₂-merc membrane) exhibits a water permeation rate of 35.7 mol/m²/h, while the membrane having thio-groups grafted thereon conferred by reacting MoS₂ nanosheets with cysteine (i.e., MoS₂-cyst membrane) exhibits a water permeation rate of and 43.3 mol/m²/h.

Examples of charged solutes that may be present in the fluid include, but are not limited to Na⁺, K⁺, Ca²⁺, Mg²⁺, and the like. According to some embodiments of the present disclosure, the membrane of about 200 nm in thickness may remove at least 96% of charged solutes (e.g., sodium ions) in the fluid, such as at least 96%, 97%, 98% or 99% of charged solutes in the fluid. According to other embodiments of the present disclosure, the membrane of about 600 nm in thickness may remove at least 99% of charged solutes (e.g., sodium ions) in the fluid, such as at least 99.1%, 99.2%, or 99.3% of charged solutes in the fluid. According to further embodiments of the present disclosure, the membrane of about 1,300 nm in thickness may remove at least 99.5% of charged solutes (e.g., sodium ions) in the fluid, such as at least 99.5%, 99.7%, or 99.8% of charged solutes in the fluid. According to optional embodiments of the present disclosure, the membrane described herein may also filter out uncharged solutes (e.g., dyes) in a fluid.

The present invention will now be described more specifically with reference to the following embodiments, which are provided for the purpose of demonstration rather than limitation. While they are typically of those that might be used, other procedures, methodologies, or techniques known to those skilled in the art may alternatively be used.

### EXAMPLES

### Material and Methods

Exfoliation of MoS₂ bulk powder. Exfoliation of bulk MoS₂ powder was carried out through electrochemical exfoliation lithium intercalation. Briefly, a slurry containing MoS₂ powder, carbon black, and poly (vinylidene fluoride) (8:1:1) mixed with N-methyl-2-pyrrolidone was fabricated into an electrode. The resulting coin cell was then assembled as a cathode and discharged to induce lithium intercalation. Upon completion of the discharging process, the lithium-intercalated cathode (LiₓMoS₂) was separated from the disassembled cell. The MoS₂ nanosheets were obtained via sonication of the electrodes in deionized water, during which the generated hydrogen gas accelerated the exfoliation of the bulk MoS₂. The centrifugation and re-dispersion process, which was repeated three times, was necessary to remove multiple or fewer-layer MoS₂.

Functionalization of single-layer MoS₂ nanosheets. Functionalization of single-layer MoS₂ nanosheets with a thio-group containing compound (i.e., cysteine, 1-propanethiol, or 3-mercaptopropane-1,2-diol) was performed in either an aqueous or an organic solution. Typically, the thio-group containing compound was dissolved in deionized water or a mixed solution (deionized water: dimethyl sulfoxide=2:1 in volume) at a concentration of 10 mM. The solution was then added to the MoS₂ dispersion and functionalized for 24 hours.

Preparation of functionalized MoS₂ membranes. Functionalized MoS₂ membranes were fabricated through vacuum filtration on a polymeric substrate (nylon or polyvinylidene fluoride) with a pore size of 220 nm and a diameter of 25 mm. The thickness of the MoS₂ membrane could be altered by changing the volume of the filtrated solution. The MoS₂ membranes functionalized with cysteine, 3-mercaptopropane-1,2-diol and 1-propanethiol were denoted as MoS₂-cyst, MoS₂-merc and MoS₂-prop, respectively. Excess reagents in the membrane were eliminated by rinsing with ethanol (3×20 mL) and water (3×20 mL). It should be noted that 1-propanethiol was dissolved in a DMSO mixed solution, requiring an additional Raman test to ensure the elimination of residual DMSO. Finally, the membranes were dried under atmospheric pressure.

Preparation of MXene and GO) membranes. MXene nanosheets were fabricated according to a previously reported method (Ding et al., Nat. Commun. 2018, 9 (1), 155). MXene membranes were prepared by vacuum filtration of purified MXene nanosheets solution on the substrates. Graphene oxide (GO) nanosheets were synthesized based on the modified Hummers method (Marcano et al., ACS Nano 2010, 4 (8), 4806-4814; Mei et al., Analyst 2020, 145 (10), 3749-3756). The purified GO nanosheets were dispersed in deionized water, and then the GO membrane was successfully fabricated by vacuum filtration on a polyvinylidene fluoride substrate.

Characterization. The top view and side view of functionalized membranes were obtained by Scanning electron microscopy (SEM, TESCAN MIRA4). The transmission electron microscopy (TEM) and energy-dispersive X-ray spectroscopy (EDS) were conducted on Tecnai G2 spirit Twin operated at 200 keV. X-ray Diffraction (XRD) was carried out on Bruker D2 PHASER X-ray diffractometer (Cu Kα radiation source, λ=1.54 Å). The images of atomic force microscopy (AFM) were recorded on Dimension 3100 (Veeco, CA). Fourier Transform Infrared (FT-IR) spectroscopy was performed by PerkinElmer Spectrum II FT-IR spectrometer. The Raman spectroscopy was conducted on WITEC 300R with a 532 nm exciting wavelength. X-ray photoelectron spectroscopy (XPS) was conducted on Thermo Scientific K-Alpha Nexsa, and calibrated with the reference C 1s peak located at 284.6 eV. The zeta potential of aqueous solution was measured on Malvern Zetasizer Nano series at neutral pH. The contact angle of membranes was carried out on DataPhysics Contact Angle Tester. Ultraviolet-visible spectroscopy (UV-Vis) was recorded on HITACHI UH4150. The solid-state ¹³C CP MAS NMR experiments were performed on a Bruker 700 MHz (16.4T) spectrometer at a frequency of 176.05 MHz, using Bruker MAS probes spinning at 10 kHz. The ¹³C solution NMR was conducted on a Bruker 400 MHz spectrometer. The X-band electron paramagnetic resonance (EPR) spectra were collected at room temperature using a Bruker EMX Plus spectrometer with 5 mg of functionalized MoS₂ and pristine exfoliated MoS₂ powder loaded in a quartz tube. The HAADF-STEM images were collected on a FEI Titan Themis G2 200 Probe double-spherical aberration (Cs) Corrected Scanning Transmission Electron Microscope operated at an accelerating voltage of 60 kV.

Forward osmosis filtration for salts and dyes. To investigate the efficacy of forward osmosis filtration for removing salts and dyes, water permeation experiments were carried out using a custom-made U-shaped device at a constant room temperature of 25° C.±0.4° C. The device consisted of two compartments: a feed side and a draw side, with a functionalized MoS₂ membrane fixed tightly in the middle. Initially, the feed and draw compartments were filled to the same height with 0.5 M NaCl solution and 2 M sucrose solution, respectively. Magnetic stirring was employed in both compartments to reduce concentration polarization effects, and average water permeation was measured three times independently. Long cycles of water permeation were repeated using the same apparatus. For dye tests, the feed side was replaced with 3.5 mM testing dyes (Rhodamine B, Methyl blue, Methyl Orange), while the draw side remained unchanged. The concentration of the draw side was measured using a conductivity meter and inductively coupled plasma-optical emission spectrometry (ICP-OES) at room temperature. The concentration of dyes was quantitatively analyzed using ultraviolet-visible spectroscopy (UV-Vis) according to the Lambert-Beer law.

All measurements were conducted three times independently. The water flux (J_{w}, mol m⁻² h⁻¹ bar⁻¹) and salt flux (Jₛ, mol m⁻² h⁻¹) were derived using the following equations:

$${J}_{w} = \frac{ρ \times Δ V}{Δ π \times A \times Δ t \times {M}_{w}} \qquad ( 1 )$$

$${J}_{s} = \frac{V \times c}{A \times Δ t} \qquad ( 2 )$$

where ρ is the density of water, ΔV is the increased volume in the draw side, V is the total volume of draw side, c is the concentration of salts obtained from calibration curves, A is the effective surface area of the membrane and Δt is the permeation time.

The calculation of osmotic pressure:

$$Δπ = M \times R \times T \qquad ( 3 )$$

where M is the difference in molar concentration of the draw and feed solution (including cation and anion, mol/L), R is the gas laws constant (0.0821 L·bar·K⁻¹·mol⁻¹) and T is the testing kelvin temperature (298 K).

The water/salt selectivity was calculated by J_{w}/Jₛ and upper bound figure was illustrated according to a previous method (Yang et al., J. Membr. Sci. 2019, 590, 117297). Note that the calculation of rejection of seawater and dyes in forward osmosis system was different from that in reverse osmosis operations owing to the presence of draw side. To exclude the dilution induced by the draw solution, the real concentration of the permeated saline solution or dyes was derived from the following,

$${C}_{P} = \frac{{C}_{D} \times {V}_{D}}{{∇}_{P}} \qquad ( 4 )$$

where C_{D} and V_{D} are the measured concentration of salts or dyes in the draw side and the volume of the draw solution. The V_{P} represents the volume of permeated solution, which is the increased volume in the draw side. The rejection was evaluated by the following equation:

$$R = \frac{{C}_{F} - {C}_{P}}{{C}_{F}} \times 100 \% \qquad ( 5 )$$

Long-term stability of forward osmosis testing. Long-term ionic permeation (100 h) for membranes was conducted in H-shape cell, similar to custom-made U-shape device. The feed side and draw side were filled with synthetic seawater and 2 M sucrose solution at the same height. The draw solution was collected every 20 h and analysed by ICP-OES three times to evaluate the average concentration of Na⁺, K⁺, Ca²⁺, Mg²⁺. (The synthetic seawater herein was a mixture of KCl, 0.0093 M; NaCl, 0.42 M; Na₂SO₄, 0.029 M; CaCl₂, 0.011 M and MgCl₂, 0.056 M.)

### Example 1: Characterization of the Present Functionalized MoS₂ Membrane

Functionalized single-layer MoS₂ nanosheets were produced in accordance with procedures described in the “Materials and methods” section. The functionalized nanosheets were denoted as MoS₂-cyst, MoS₂-merc, and MoS₂-prop, respectively. For 1-propanethiol, functionalization was performed in a mixture of dimethyl sulfoxide (DMSO) and deionized water due to the hydrophobicity of the alkyl chain. Note that there was no DMSO residue after functionalization. The functionalized nano-laminated membranes were fabricated through a vacuum filtration method as described in the “Materials and methods” section.

Transmission electron microscopy (TEM) image showed the morphology of the functionalized nanosheet, with the hexagonal diffraction pattern of the nanosheet confirming the MoS₂ lattice structure. Energy-dispersive spectroscopy (EDS) mapping revealed uniform distribution of nitrogen (N) and sulfur (S) elements on MoS₂-cyst nanosheets. Furthermore, TEM images revealed that the interlayer spacing of MoS₂-cyst nanolaminate expanded to 11.3 Å, which differed from the original spacing of MoS₂ crystals (6.2 Å). Cross-section image of the MoS₂-cyst nano-laminated membranes with a thickness of around 1,300 nm indicated that the functionalized MoS₂ nanosheets were restacked in an ordered sequence. By controlling the volume of filtrated solution, the nanolaminate membranes with different thicknesses (200, 600, 1300 nm) could be prepared with smooth surface. Importantly, no obvious pinholes were observed from the magnified top-view scanning electron microscopy (SEM) images of the three membranes. Based on AFM measurements, the average surface roughness of the synthesized MoS₂-cyst, MoS₂-merc and MoS₂-prop membranes are 44.8 nm, 39.9 nm, and 45.8 nm, respectively, indicating comparable surface roughness for different thiol-groups (S—H) functionalized MoS₂ membranes.

To reveal the covalent functionalization of MoS₂ by thiol-groups, several characterization techniques were employed in the present example. STEM image of the basal plane of pristine exfoliated MoS₂ showed a characteristic hexagonal pattern of 2H-MoS₂. The existence of S vacancies (Vₛ) was clearly observed either by direct images or by the intensity profile analysis of the STEM image along a specified area.

FT-IR spectra was then used to confirm the changes of functionalization of various groups onto MoS₂ membranes. As expected, pure MoS₂ membrane did not display any vibration peaks, while pure cysteine, 3-mercapto-1,2-propanediol, and 1-propanethiol showed S—H stretching with a frequency (VSH) located at 2550, 2556, and 2561 cm⁻¹, respectively. After functionalization, the S—H stretching peaks disappeared, indicating that the S—H ligands of cysteine, 3-mercapto-1,2-propanediol, and 1-propanethiol were deprotonated and C—S moiety grafted onto the Vₛ position of MoS₂ nanosheets in the form of C—S-Mo state. The reduced vacancies were also confirmed by mass-normalized electron paramagnetic resonance (EPR) spectroscopy. The peak intensity detected at ˜3510 Gauss was expected to be proportional to the concentration of sulfur vacancies. The pristine exfoliated MoS₂ nanosheets without functionalization exhibited stronger signals, almost two-fold larger than that of the functionalized MoS₂ (MoS₂-cyst, MoS₂-merc, MoS₂-prop) nanosheets. This suggested that these molecules were successfully grafted onto S vacancies of the exfoliated MoS₂ nanosheets and eliminating the vacancies effectively.

X-ray diffraction (XRD) was conducted to demonstrate that the successful functionalization onto Vₛ gave rise to the enlargement of interlayer spacing of the functionalized MoS₂ membranes. It was found that the peak of the (002) planes for the pristine MoS₂ membrane was located at approximately 14.2°, representing an interlayer spacing (d) of 6.4 Å. This value was in close proximity to the position of bulk MoS₂ powder (14.3°), thus validating the quasi-perfect restacking of the pristine nanosheets similar to that of bulk MoS₂. The (002) planes of MoS₂-cyst, MoS₂-merc and MoS₂-prop were observed to shift to lower angles of 7.9°, 8.2° and 7.8°, respectively, corresponding to interlayer spacings of 11.3 Å, 10.9 Å and 11.4 Å, respectively. This trend indicated that grafted functional groups on the MoS₂ nanosheets could regulate the interlayer spacing of the restacked MoS₂ nanosheets, paving the way for water desalination. The capillary width of non-functionalized MoS₂ membrane was approximately 0.2 Å, whereas for cyst-, merc- and prop-functionalized MoS₂ membranes, the capillary widths were 5.1 Å, 4.7 Å and 5.2 Å, respectively. This information was based on XRD data that subtracted the interlayer spacing of 6.2 Å in bulk MoS₂.

To qualitatively analyze the covalent nature of the functionalization, ¹³C cross polarization magic angle spinning nuclear magnetic resonance (CP MAS NMR) was utilized to discern the chemical environment of carbon of the functional group before and after functionalization. The chemical shifts of C—S bond could serve as indicators of the chemical environment in functional groups. Liquid-state NMR of pristine thiol reagents was used as references. The characteristic chemical shifts of carbon bound to sulfur (C—S) detected at δ=24.6 ppm, 26.5 ppm, and 77.4 ppm corresponded to cysteine, 3-mercapto-1,2-propanediol, and 1-propanethiol, respectively. After functionalization, the corresponding C—S bond of functionalized MoS₂ membranes (MoS₂-cyst, MoS₂-merc, MoS₂-prop) relocated to 27.8 ppm, 34.5 ppm, and 112.5 ppm, respectively. The carbon chemical shift was attributed to the formation of covalent bonds between S atoms (from the deprotonated-SH group of the thiols) and the Mo atom at S vacancies sites. Furthermore, based on ab initio molecular dynamics (AIMD) simulations of the functionalized membranes in explicit water, the averaged S—C bond lengths and average bond energies of MoS₂-cyst, MoS₂-merc, and MoS₂-prop were evaluated to be 1.85±0.04 Å and 1.81±0.32 eV, respectively, which confirmed the covalent functionalization of the MoS₂ membranes.

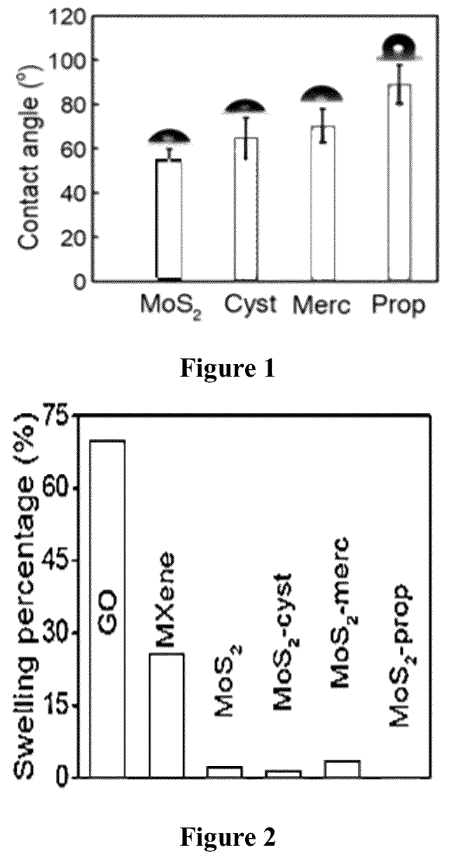

The data in FIG. 1 confirmed that functionalization of MoS₂ membranes altered their surface wettability, with contact angles being 64.8°, 70.3°, and 90° for MoS₂-cyst, MoS₂-merc, and MoS₂-prop, respectively, compared to 53.9° for non-functionalized MoS₂. This result suggested that different functional groups can modify the surface chemistry of membranes.

X-ray photoelectron spectroscopy (XPS) was further used to analyze the chemical composition of the functionalized MoS₂ nanosheets. The successful functionalization of cysteine on MoS₂ nanosheets was confirmed by the detection of N1s spectrum in MoS₂-cyst functionalized membranes, which was consistent with the EDS mapping results. The Mo 3d spectrum (223-234 eV) showed negligible changes in the relative components of the 1T and 2H phases for both pristine and functionalized MoS₂ nanosheets, indicating that the functionalization process did not alter the phase of the MoS₂ nanosheets. Deconvolution of the S 2p spectrum (158-166 eV) showed that the pristine MoS₂ nanosheets exhibited two doublets of S 2p, in line with the 1T and 2H phase of exfoliated MoS₂. However, for functionalized MoS₂ (MoS₂-cyst, MoS₂-merc, MoS₂-prop), additional doublets of S 2p were observed, indicating the presence of S—C bonds originating from these functionalized groups. The degree of functionalization was calculated based on the percentage of the S—C bond compared to the overall S 2p spectrum, with functionalization percentages of 14%, 10%, and 10% for MoS₂-cyst, MoS₂-merc, and MoS₂-prop membranes, respectively. C 1s XPS spectra of pristine and functionalized MoS₂ membranes were also compared to confirm successful functionalization of different molecules. The adventitious carbon located at 284.8 eV was used for sample calibration, which was present in both pristine and functionalized MoS₂ nanosheets. Additional C═O (285-290 eV) and C-X (285-288 eV) peaks were observed in MoS₂-cyst membrane, while MoS₂-merc membrane showed additional C-X (284-288 eV) peak, and MoS₂-prop membrane exhibited additional C-X (285-289 eV) peak.

Raman spectra of pristine and functionalized MoS₂ (MoS₂-cyst, MoS₂-merc, MoS₂-prop) membranes, as well as functionalized MoS₂ membranes after long-term FO test filtration cycles, indicated that the functionalization procedure and extended testing did not alter the structure or phase of the MoS₂ membranes. The distinctive in-plane E¹_{2g} (378 cm⁻¹) and out-of-plane A_{1g} (406 cm⁻¹) peaks were clearly visible in the pristine MoS₂ membranes with strong peak intensity. After functionalization with various functional groups, these E¹_{2g} and A_{1g} signals of the MoS₂ membranes were still preserved. Even after 11 cycles of FO processes, the E¹_{2g} and A_{1g} peaks of the functionalized MoS₂ membranes were still intact with strong intensity. Furthermore, post-filtration SEM characterization of functionalized MoS₂ membranes was performed, and the results showed the intact laminated structures and surfaces without pinholes after filtration. The preserved morphology indicated the strong stability of the functionalized MoS₂ membranes in aqueous solution with anti-fouling behavior.

The swelling behavior of a membrane in an aqueous solution is an essential criterion for evaluating its stability. In this study, the swelling properties of various 2D materials-based membranes were investigated. As indicated in FIG. 2, the swelling percentages of GO and MXene could reach up to ˜70% and ˜27%, respectively, which were unsuitable for continuous desalination testing. By contrast, the functionalized MoS₂ membranes exhibited limited swelling behavior of 1.3% (MoS₂-cyst), 3.7% (MoS₂-merc), and 0.6% (MoS₂-prop) only after soaking for 24 hours in water. The swelling percentages of MoS₂-cyst and MoS₂-merc were comparable with pristine MoS₂ membranes (2%) due to the presence of hydrophilic functional groups, while MoS₂-prop showed slightly lower swelling percentages than pristine MoS₂ membranes, which might be attributed to the hydrophobic behavior of the functional group. Overall, the swelling of the functionalized MoS₂ membranes was found to be much lower than that of GO or MXenes. The data strongly supported that covalent functionalization of MoS₂ with thiol-groups was an effective route to enlarge the interlayer spacing while exhibiting good anti-swelling properties.

### Example 2: Desalination Performance of the Functionalized MoS₂ Membrane of Example 1

### 2.1 Ion Rejection

In this example, the sieving performance of three functionalized MoS₂ nanolaminate membranes (i.e., MoS₂-cyst, MoS₂-merc, and MoS₂-prop) and pristine MoS₂ membrane with different thicknesses (200, 600, or 1,300 nm) was investigated in a custom-made filtration device, which had two cells respectively filled with draw solution and feed solution. In this study, 2 M sucrose solution was used as the draw solution and 0.5 M NaCl served as the feed solution to mimic the real concentration of seawater.

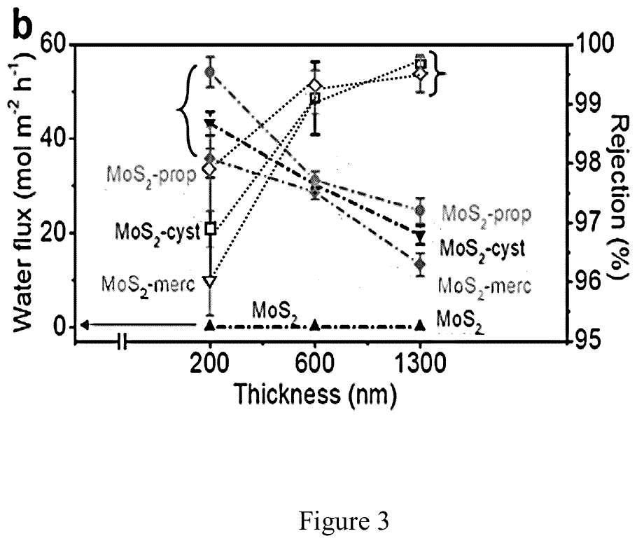

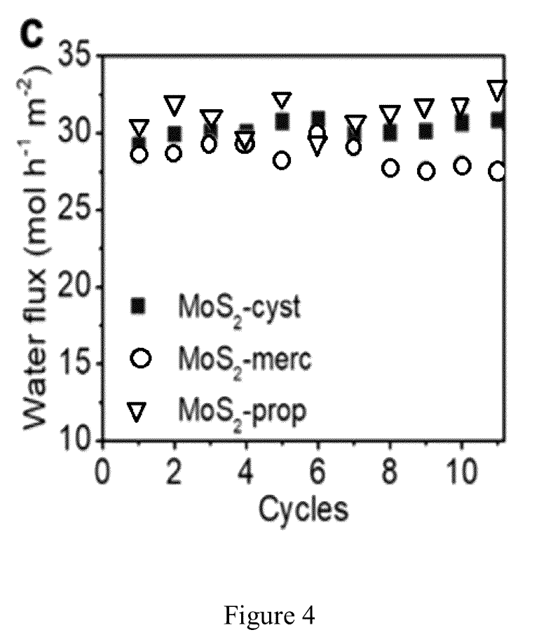

The water flux of the pristine or functionalized MoS₂ membranes was measured. It was found that pristine MoS₂ membranes did not exhibit any water flux, which was consistent with previous findings in reverse osmosis. However, after being functionalized with Cysteine, 3-Mercapto-1,2-propanediol, or 1-Propanethiol, water could efficiently permeate through all these functionalized MoS₂ membranes while maintaining high rejection of salt ions. As the thickness of the functionalized membranes increased from 200 nm to 600 nm, finally to 1300 nm, the water flux of the functionalized membranes (MoS₂-cyst, MoS₂-merc, MoS₂-prop) decreased from 43.3, 35.7, 54.1 mol m⁻² h⁻¹, to 30.2, 28.6, 31.1 mol m⁻² h⁻¹, and eventually to 19.6, 13.3, 24.7 mol m⁻² h⁻¹, respectively, which was probably due to the increased diffusion path of the water molecules. For 200 nm-thick membranes, prop-functionalized MoS₂ membranes exhibited the highest (54.1 mol m⁻² h⁻¹) water permeation across the membrane, surpassing the water flux of GO and MXene membrane. The water flux of MoS₂-prop at a thickness of 600 nm could reach 2.626 mol m⁻² h⁻¹ bar⁻¹, which was better than previously reported MoS₂ membranes (1.544 mol m⁻² h⁻¹ bar⁻¹), GO/Graphene membrane (0.372 mol m⁻² h⁻¹ bar⁻¹), and MXene membrane (1.222 mol m⁻² h⁻¹ bar⁻¹)¹⁰ at a similar rejection (˜99%). Regarding the rejection of the three functionalized membranes (MoS₂-cyst, MoS₂-merc, MoS₂-prop), for 200-nm-thick membrane, the Na⁺ rejections were 96.9%, 96%, 97.9%, respectively, while the values increased to 99.1%, 99.1%, 99.3%, respectively, for 600-nm-thick membrane, eventually with achieved 99.7%, 99.7%, 99.5%, respectively, for 1,300-nm-thick membrane (FIG. 3). To assess the stability of the functionalized MoS₂ membranes, 11 filtration cycles were conducted using 600 nm-thick membranes with the draw and feed solutions being replenished before each cycle. The results indicated that these three functionalized membranes (MoS₂-cyst, MoS₂-merc, MoS₂-prop) exhibit superior cycling stability (FIG. 4).

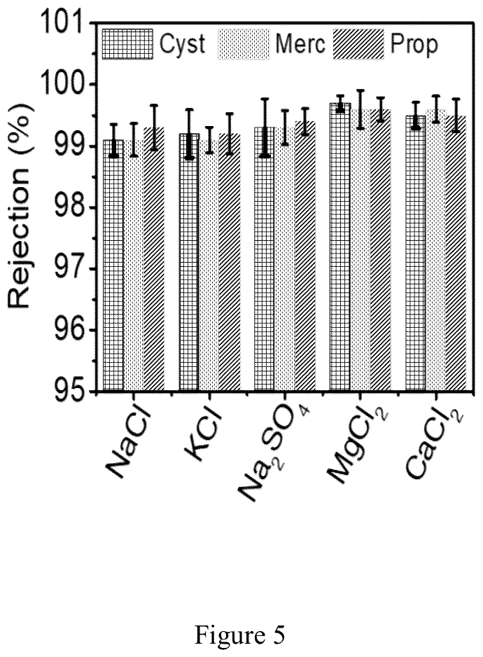

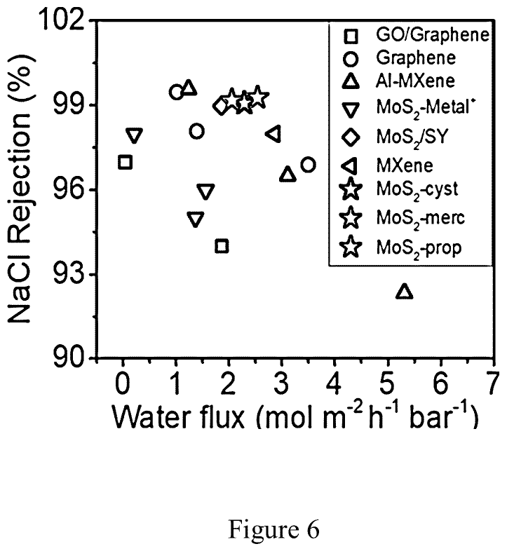

Further, by operating the FO filtration for 24 hours, the functionalized MoS₂ membranes (MoS₂-cyst, MoS₂-merc, or MoS₂-prop, each was 600 nm in thickness) all exhibited high rejection (>99%) toward various hydrated ions (Na⁺, K⁺, Ca²⁺, Mg²⁺) (FIG. 5). Specifically, MoS₂-prop membrane achieved the highest Na⁺ rejection of 99.3% by using 0.5 M NaCl as the feed solution. In addition, the salts rejection increases from K⁺ (99.2%) to Na⁺ (99.3%), Ca²⁺ (99.5%) and Mg²⁺. (99.6%), respectively, which are due to the increased hydrated diameters from 6.6 Å (K⁺), to 7.2 Å (Na⁺) 8.2 Å (Ca²⁺) and 8.6 Å (Mg²⁺), respectively. The salts rejection of cyst-and merc-functionalized MoS₂ membranes showed similar trends with MoS₂-prop membrane, demonstrating that the functionalized MoS₂ nanolaminates membrane can reject both multivalent ions and monovalent ions effectively. Comparing the desalination performances with other reported 2D inorganic nanosheets membranes (FIG. 6), the present functionalized MoS₂ membranes exhibited higher rejection and water flux than most GO and TMD-based membranes.

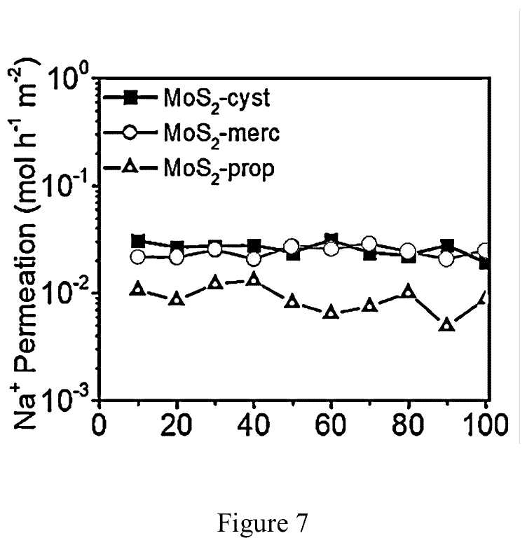

To further confirm the ion permeation of functionalized membranes, 100-h continuous experiments were carried out. The long-term Na⁺ permeation rate depicted in FIG. 7 showed a stable trend under the 100-h operating condition. The average permeation of Na⁺ in MoS₂-prop membrane was 0.0106 mol h⁻¹ m⁻², which was significantly lower than MoS₂-cyst membrane (0.0259 mol h⁻¹ m⁻²) or MoS₂-merc (0.0239 mol h⁻¹ m⁻²) membrane, and this clearly evidenced excellent sieving performance of MoS₂-prop membranes. Such a low ion permeation in the MoS₂-prop membrane could be attributed to steric hindrance of MoS₂-prop membrane since its capillary width (5.2 Å) was lower than the diameters of hydrated ions (6.6˜8.6 Å). Overall, the data demonstrated that the functionalized MoS₂ membranes could be operated consecutively for at least 100 hours with stable ion flow.

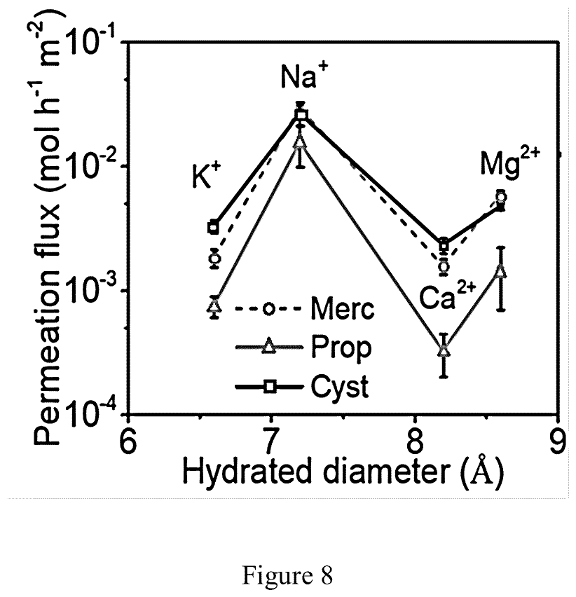

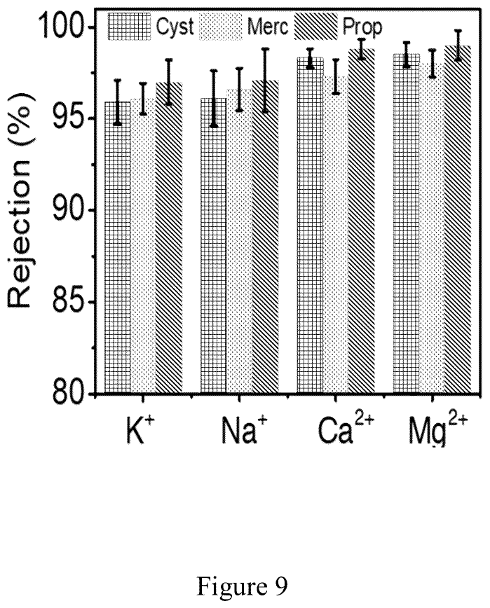

The performance of functionalized MoS₂ membranes under realistic operation conditions was further tested in synthetic seawater that served as feed solution for 100 h. The composition of synthetic seawater included KCl (0.0093 M), NaCl (0.42 M), Na₂SO₄ (0.029 M), CaCl₂ (0.011 M) and MgCl₂ (0.056 M). Noted that the Na⁺ exhibited the highest concentration among all the ions, thus gave rise to the highest permeation rate. As shown in FIG. 8, all cations' permeation flux (Na⁺, K⁺, Ca²⁺, Mg²⁺) through the functionalized MoS₂-prop membrane were lower when compared with MoS₂-cyst and MoS₂-merc membranes. This was attributed to the narrower capillary width of MoS₂-prop, leading to lower permeation of cation. FIG. 9 demonstrated that after 100-h operation, the MoS₂-prop membrane (600 nm) maintained the highest Na⁺ rejection of 97.3% compared with MoS₂-cyst (96.0%) and MoS₂-merc (96.4%) membranes, further demonstrating its excellent desalination performance and stability towards synthetic seawater.

Furthermore, we carried out tests for chlorine tolerance of the functionalized MoS₂-prop membrane since chlorine is commonly employed to mitigate biofouling. The regeneration performance was studied by repeating exposure to diluted sodium hypochlorite solution (200 ppm). After six cycles, the MoS₂-prop membrane (600 nm) still exhibited very high Na⁺ rejection (around 90%), which is comparable with commercial CTA polymeric membranes (data not shown). In addition, XRD measurements revealed that after NaClO treatment, the MoS₂-prop membrane still achieved a diffraction peak at around 7.8° without peak shifting compared with the original MoS₂-prop membrane, indicating that this MoS₂-prop membrane had a strong chlorine resistance with good stability.

The properties of membrane separation are limited by the trade-off between permeability and selectivity. As a result, the evaluation of FO membrane separation can be directly determined through the trade-off relationship between water-salt permeability-selectivity and the water permeability coefficient. Specifically, the water-salt permeability-selectivity (bar⁻¹) was measured by the ratio of water permeation (mol m⁻² h⁻¹ bar⁻¹) and salt flux (mol m⁻² h⁻¹). The water/salt selectivity of MoS₂-prop reached 800 bar⁻¹, which was higher than MoS₂-cyst (554 bar⁻¹) and MoS₂-merc (511 bar⁻¹) and was also higher than GO and MXene membranes (data not shown). The results demonstrated excellent performance of the present functionalized MoS₂ membranes.

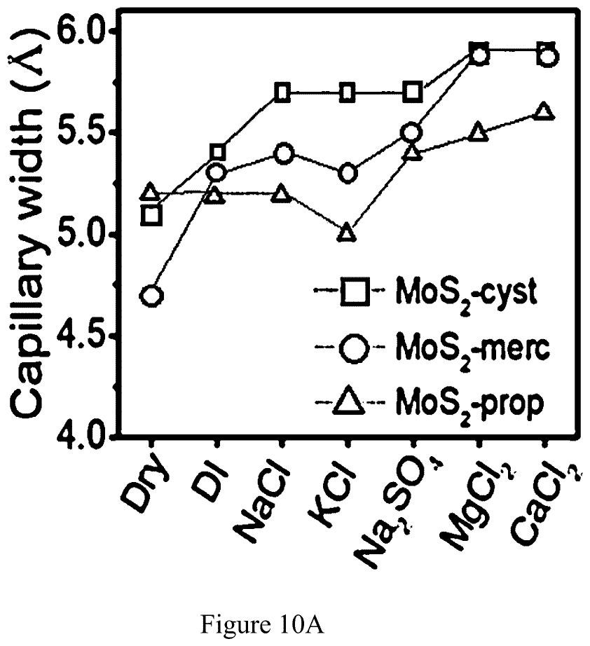

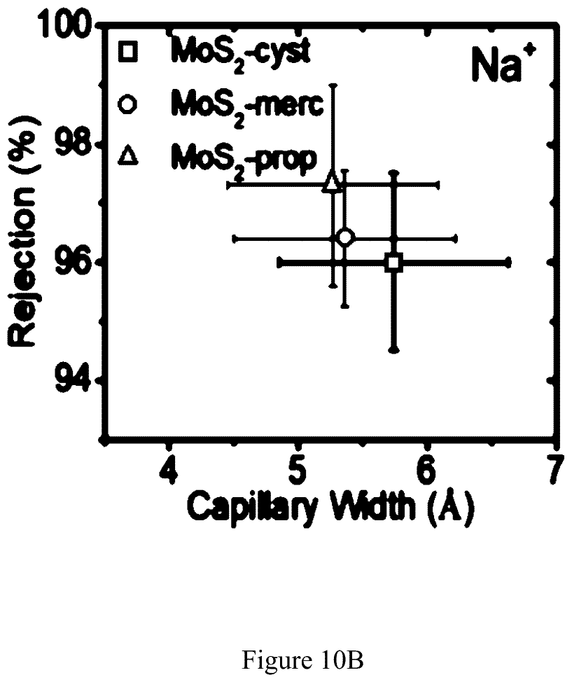

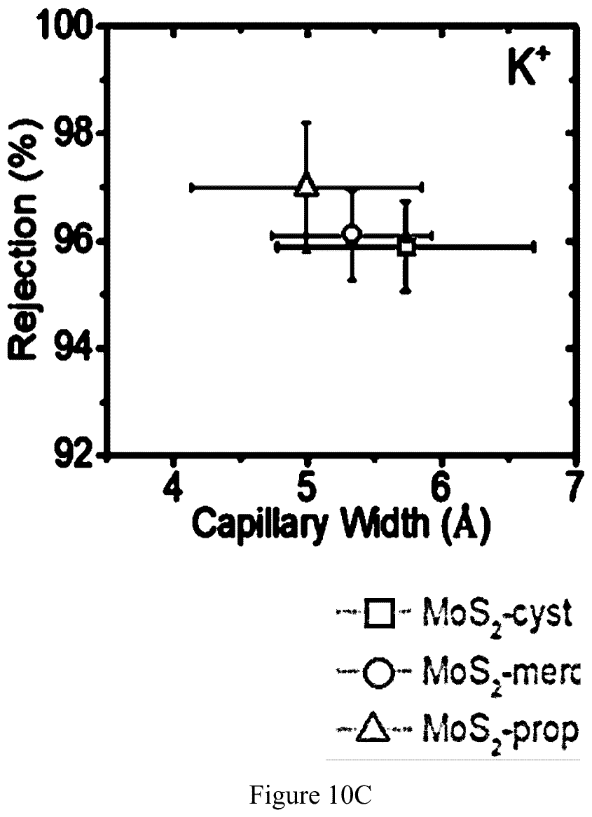

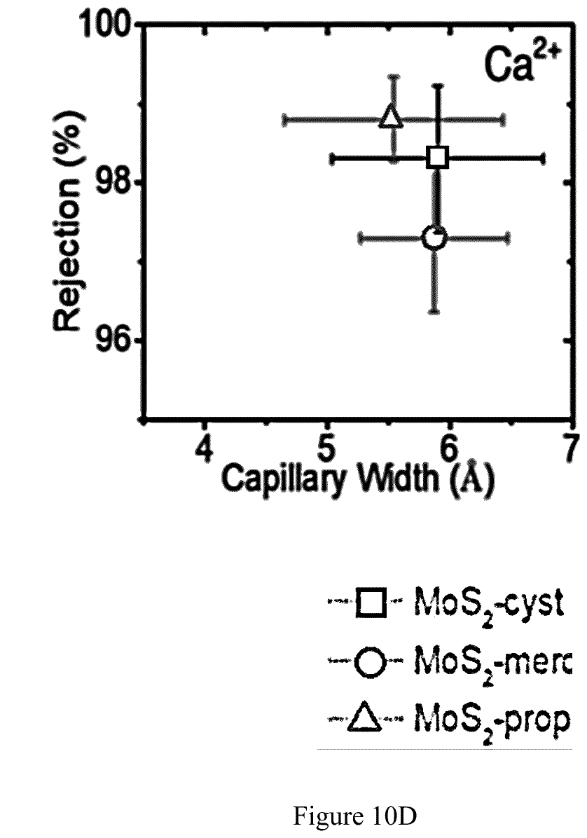

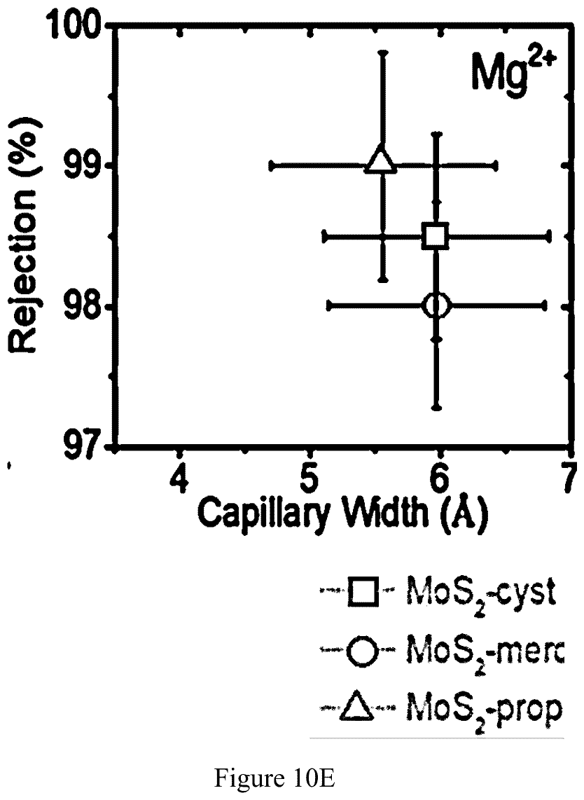

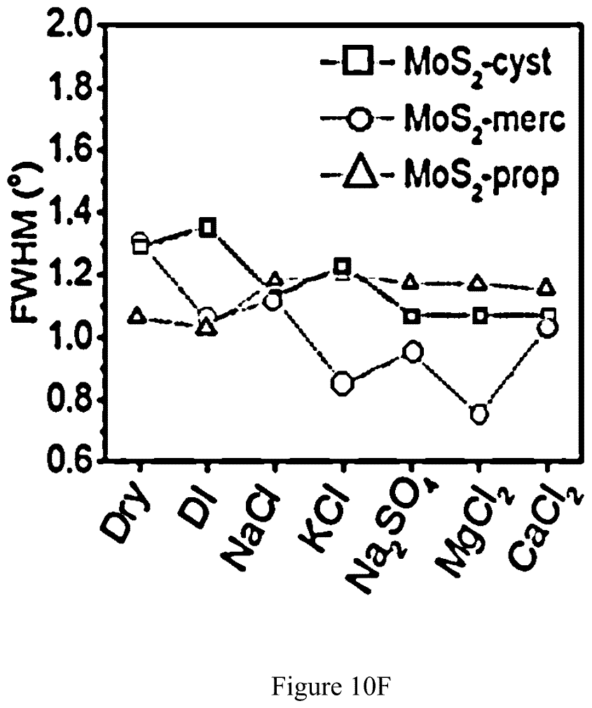

To measure the interlayer spacing of MoS₂-cyst, MoS₂-merc and MoS₂-prop membranes in aqueous solution, the XRD data of these membranes were investigated by soaking the membranes in DI water or 0.5 M saline solution (NaCl, KCl, Na₂SO₄, MgCl₂, CaCl₂) for 24 hours. For instance, in NaCl solution, the (002) peaks of MoS₂-cyst, MoS₂-merc and MoS₂-prop membranes were located at 7.4°, 7.6°, 7.8° corresponding to the capillary widths of 5.7 Å, 5.4 Å, and 5.2 Å, respectively. In contrast, the original capillary widths were 5.1 Å, 4.7 Å, and 5.2 Å, respectively. The summarized capillary widths are presented in FIG. 10A. For MoS₂-cyst, the capillary width increased to 5.4 and 5.7 Å, respectively, when the membranes were immersed in DI water and NaCl solution; and it further increased to 5.9 Å in the saline solution of Ca²⁺ and Mg²⁺, since the diameter of these hydrated ions were further increased. The capillary width of the membranes in saline solutions (FIG. 10A) was then correlated with long-term (100 h) rejection (FIG. 10B-10E). Thus, the smaller the capillary width in saline solutions, the higher the rejection could achieve. For instance, MoS₂-prop membrane showed the highest Na⁺ rejection (97.3%) with the smallest capillary width in NaCl solution (5.2 Å), while MoS₂-cyst showed the lowest Na⁺ rejection (96.0%) with the largest capillary width (5.7 Å) and MoS₂-merc the middle (96.4% and 5.4 Å). However, it is hard to distinguish MoS₂-cyst and MoS₂-merc membranes presented in Ca²⁺ and Mg²⁺ solution due to the very close capillary widths of them under this saline solution (FIG. 10D, 10E). These results indicated the ion flow was limited by capillary width, which also showed the strong nanochannel effect in functionalized MoS₂ nanolaminates.

To further reveal the underlying factors for the higher water flux of MoS₂-prop membranes, the structure of functionalized MoS₂ nanolaminates with a thickness of 600 nm was evaluated by full width at half-maximum (FWHM) of (002) peaks from XRD pattern, as shown in FIG. 10F. The FWHM of the diffraction peaks can be regarded as a factor in qualitatively assessing the stacking disorder in 2D nanolaminates. In FIG. 10F, the FWHM of MoS₂-prop in NaCl solution (1.18 Å) was larger than MoS₂-merc (1.12 Å) and MoS₂-cyst (1.13 Å) in the same solution. Hence the water flux of MoS₂-prop (54.1 mol m⁻² h⁻¹) using NaCl solution was a bit higher than MoS₂-merc (35.7 mol m⁻² h⁻¹) or MoS₂-cyst (43.3 mol m⁻² h⁻¹). This could be attributed to the fact that the larger disordered structure may lead to the fluctuation of stacking sequence of the nanosheets, to some extent reducing effective path length of water transport between functionalized MoS₂ layers, further enhancing the water permeation.

The capability of the functionalized MoS₂ membranes to reject various dyes was also evaluated. The performances of functionalized MoS₂ membranes before and after organic dyes rejection were assessed using UV-Vis spectrophotometry according to Lambert-Beer Law. Three kinds of pigments, e.g. Rhodamine B, Methyl Blue, and Methyl orange were selected for testing the rejection in the FO configuration. All these functionalized membranes (MoS₂-cyst, MoS₂-merc, MoS₂-prop; 600 nm thickness) exhibited rejection higher than 90% (data not shown). When comparing the rejection value of each membrane with the molecular weight of target dyes, one could observe that the rejection values increased linearly with the molecular weights. In other words, the larger the molecular weight of the dye, the higher the rejection value, suggesting weight-limiting was the primary reason in the sieving mechanism. The MoS₂-prop membrane having the narrowest capillary width exhibited the highest rejection for different dye molecules. From the results, one could conclude that controlling the interlayer spacing of the functionalized MoS₂ membranes is the dominant parameter for sieving out molecules or ions, which is in agreement with previous literature results regarding nano-laminated membranes.

The present study takes advantage of the sulfur vacancies in exfoliated MoS₂ nanosheets, utilizing three different functional molecules cysteine, 3-mercapto-1,2-propanediol, and 1-propanethiol containing S—H group to successfully functionalize the nanolaminates. As a result, the capillary width of the MoS₂ nanolaminates could be adjusted from the original 0.2 Å in pristine MoS₂ to 5.2 Å in prop-functionalized MoS₂, enabling water permeation in FO. The MoS₂-prop membrane displayed the highest water flux (54.1 mol m⁻² h⁻¹) in FO when compared with MoS₂-merc (35.7 mol m⁻² h⁻¹) and MoS₂-cyst (43.3 mol m⁻² h⁻¹). This could be attributed to the fundamental interaction between water and the corresponding hydrophobic group of prop-functionalization, as confirmed by numerical simulations (data not shown). Furthermore, in NaCl solution, the capillary width of the MoS₂-prop membrane was about 5.2 Å, resulting in the highest Na⁺ rejection value (97.3%) compared to MoS₂-merc (96.4%) and MoS₂-cyst (96.0%) with capillary widths of 5.4 Å and 5.7 Å, respectively, in 100-hour long-term testing.

In sum, the present disclosure developed a functionalization approach to covalently graft different thiol-groups into the sulfur vacancy sites of MoS₂, which can control the interlayer spacing of MoS₂ nanolaminates. Systematic investigations demonstrated that MoS₂ membranes functionalized with hydrophobic group (propanethiol) exhibited enhanced sieving performance towards micropollutant purification and desalination, even in the presence of artificial seawater (salt rejection 99.3%, and water/salt selectivity 800 bar⁻¹). Experimental results highlighted the positive role of hydrophobic functional groups in improving the water flux in MoS₂ membranes. It was found that the adjustable width of the capillary channel played an important role in the efficient rejection of salts and micropollutants present in wastewater. Overall, the robust functionalization strategy provides a promising pathway for developing next-generation membranes for water reclamation.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of the present disclosure.

What is claimed is:

1. A membrane comprising stacked layers of thio-groups functionalized single-layer transition metal dichalcogenide (TMD) nanosheets,
wherein,
the thio-groups functionalized single-layer TMD nanosheets are produced by reacting a dispersion of single-layer TMD nanosheets with a thiol-group containing compound selected from the group consisting of cysteine, 1-propanethiol, and 3-mercaptopropane-1,2-diol; and
the membrane is characterized by having a network of water permeation capillary passages independently having a capillary width of about 4.5-5.5 Å, a surface wettability with a contact angle of 64-90°, a degree of functionalization of 10-15%, a degree of swelling of about 0.5-4.0%; and a thickness of about 200-1,300 nm.

2. The membrane of claim 1, wherein the dispersion of single-layer TMD nanosheets is produced by,
(i) discharging a bulk TMD in a lithium battery to produce a lithiated bulk TMD;
(ii) subjecting the lithiated bulk TMD to sonification in water to exfoliate the lithiated bulk TMD into the single-layer TMD nanosheets;
(iii) collecting the product of step (ii) by centrifugation; and
(iv) re-dispersing the product of step (iii) in water to produce the dispersion of single-layer TMD nanosheets.

3. The membrane of claim 2, wherein the single-layer TMD nanosheets are single-layer MoS₂ nanosheets.

4. The membrane of claim 3, wherein,
the thiol-group containing compound is 1-propanethiol; and
the membrane has the network of water permeation capillary passages independently having the capillary width of about 5.2 Å, the surface wettability with the contact angle of about 90°, the degree of functionalization of 10%, and the degree of swelling of about 0.6%.

5. The membrane of claim 3, wherein,
the thiol-group containing compound is cysteine; and
the membrane has the network of water permeation capillary passages independently having the capillary width of about 5.1 Å, the surface wettability with the contact angle of about 65°, the degree of functionalization of 14%, and the degree of swelling of about 1.3%.

6. The membrane of claim 3, wherein,
the thiol-group containing compound is 3-mercaptopropane-1,2-diol; and
the membrane has the network of water permeation capillary passages independently having the capillary width of about 4.7 Å, the surface wettability with the contact angle of about 70°, the degree of functionalization of 10%, and the degree of swelling of about 3.7%.

7. A method of deionizing a fluid comprising permeating the fluid through the membrane of claim 1 via forward osmosis for at least 24 hrs.

8. The method of claim 7, wherein the single-layer TMD nanosheets are single-layer MoS₂ nanosheets.

9. The method of claim 8, wherein
the thiol-group containing compound is 1-propanethiol; and
the membrane has the network of water permeation capillary passages independently having the capillary width of about 5.2 Å, the surface wettability with the contact angle of about 90°, the degree of functionalization of 10%, and the degree of swelling of about 0.6%.

10. The method of claim 8, wherein
the thiol-group containing compound is cysteine; and
the membrane has the network of water permeation capillary passages independently having the capillary width of about 5.1 Å, the surface wettability with the contact angle of about 65°, the degree of functionalization of 14%, and the degree of swelling of about 1.3%.

11. The method of claim 8, wherein
the thiol-group containing compound is 3-mercaptopropane-1,2-diol; and
the membrane has the network of water permeation capillary passages independently having the capillary width of about 4.7 Å, the surface wettability with the contact angle of about 70°, the degree of functionalization of 10%, and the degree of swelling of about 3.7%.

12. The method of claim 7, wherein the fluid comprises ions selected from the group consisting of sodium ions, potassium ions, magnesium ions, calcium ions and a combination thereof.

13. The method of claim 12, wherein the membrane rejects at least 96% of ions present in the fluid.
